(19) United States
(12) Patent Application Publication
(10) Pub. No.: US 2015/0350204 A1
(43) Pub. Date: Dec. 3, 2015

(54) CLOUD-BASED DEVICE AUTHENTICATION

(71) Applicants: Toshiba Tec Kabushiki Kaisha, Tokyo (JP); Kabushiki Kaisha Toshiba, Tokyo (JP)

(72) Inventors: Jianxin Wang, Trabuco Canyon, CA (US); Sheng Lee, Irvine, CA (US); William Su, Shenzhen (CN); Michael Yeung, Mission Viejo, CA (US)

(21) Appl. No.: 14/292,214

(22) Filed: May 30, 2014

(51) Int. Cl. H04L 29/06; G06F 17/30

(52) U.S. Cl. CPC H04L 63/0876; G06F 17/30345

(57) ABSTRACT

System, apparatus, and methods for authenticating a device for access to a server. The method includes receiving a set of device-specific attributes from the device as a part of a device registration process, storing the set of device-specific attributes in a device attribute storage, and receiving a request to perform an operation using the device and involving the server. The method further includes transmitting a set of device-specific challenge questions derived from the set of device-specific attributes to the device, receiving responses to the set of device-specific challenge questions from the device, confirming that the responses each conform to the set of device-specific attributes, and enabling the operation involving the server.

### BACKGROUND

1. Field

This disclosure relates to authentication of devices using a server.

2. Description of the Related Art

A multifunction peripheral (MFP) is a type of document processing device which is an integrated device providing at least two document processing functions, such as print, copy, scan and fax. In a document processing function, an input document (electronic or physical) is used to automatically produce a new output document (electronic or physical).

Documents may be physically or logically divided into pages. A physical document is paper or other physical media bearing information which is readable unaided by the typical human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as documents, unless the context requires some discussion of physical documents which will be referred to by that name specifically.

In printing, the MFP automatically produces a physical document from an electronic document. In copying, the MFP automatically produces a physical document from a physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organization's networks which also include various other workstations, servers and peripherals. An MFP may also provide remote document processing services to external or network devices.

Authentication of devices, such as MFPs, often involves user input of a username and password, the input of challenge protocols, such as the exchange of RSA keys that periodically change. In many cases, enabling a particular operation on a device may be best served by only ensuring that the device (as opposed to the user of the device) is authorized to perform such an operation. For example, when ordering of MFP supplies or upgrading internal software that enables a device to function, the authentication of a particular individual may be largely irrelevant to the overarching question of whether the device itself is authorized to perform the function. In such cases, prior art methods are largely inapplicable.

### DESCRIPTION OF THE DRAWINGS

FIG. 1 is a diagram of an MFP system.

FIG. 2 is a block diagram of an MFP.

FIG. 3 is a block diagram of a computing device.

FIG. 4 is a block diagram of a software system for an MFP.

FIG. 5 is a block diagram of a software system for cloud-based authentication.

FIG. 6 is a flowchart showing initialization of a cloud-based authentication process.

FIG. 7 is a flowchart showing a cloud-based authentication process.

Throughout this description, elements appearing in figures are assigned three-digit reference designators, where the most significant digit is the figure number where the element is introduced, and the two least significant digits are specific to the element. An element that is not described in conjunction with a figure may be presumed to have the same characteristics and function as a previously-described element having the same reference designator.

### DETAILED DESCRIPTION

In order to deal with authentication issues, prior art methods have relied upon individual authentication for a user or users. Occasionally, an administrator password or other authentication credentials will be stored on a device and transmitted upon request to a remote server. These systems are not particularly secure in that the authentication credentials are stored and transmitted.

Here, device-specific data about a device is transmitted, once, then subsequent interactions with the device may be authenticated by the device based upon information available to the device. This information may be, for example, a MAC address, a serial number, a model number, a manufacture date, a serial number on a sub-part of the device, a hardware revision number for some or all aspects of the device, or other unique device identifier that would be known only to the device and to the server with which it has previously communicated.

The device-specific data that forms the basis of questions to the device from the server may be randomly-selected such that the same device-specific questions rarely appear together. This may lower the probability that a third party is ever capable of obtaining all the answers or answering a given randomly-selected set of questions.

Description of Apparatus

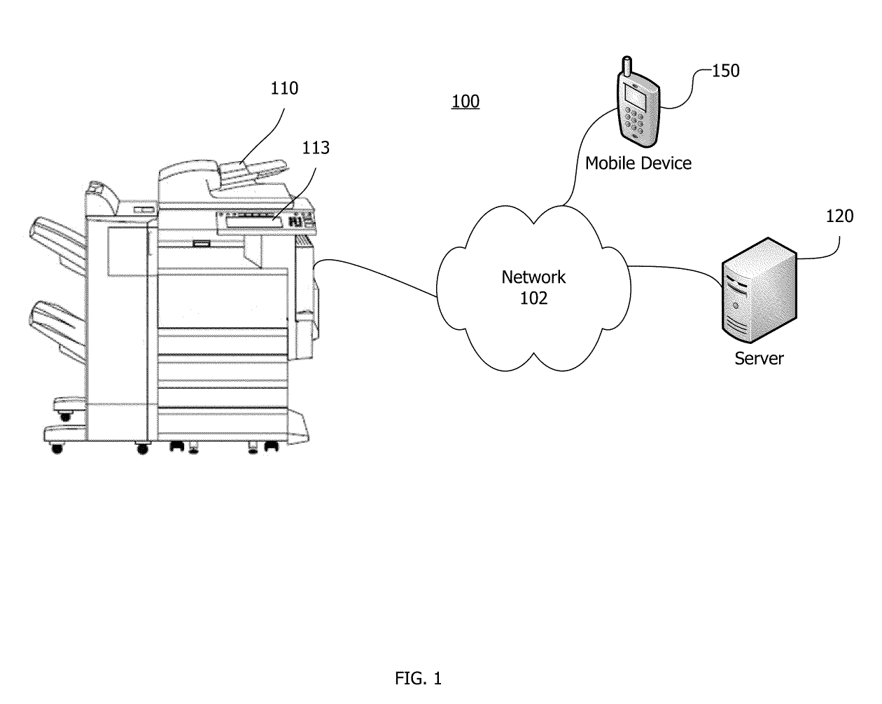

Referring now to FIG. 1 there is shown an MFP system 100. The MFP system 100 includes an MFP 110, a DNS server 120, and a mobile device 150, all interconnected by a network 102. The MFP system 100 may be implemented in a distributed computing environment and interconnected by the network 102. An MFP system 100 may include more MFPs, more or fewer servers, and more than one mobile device.

The network 102 may be or include a local area network, a wide area network, a personal area network, a mobile or telephone network, the Internet, an intranet, or any combination of these. The network 102 may have physical layers and transport layers according to IEEE 802.11, Ethernet or other wireless or wire-based communication standards and protocols such as WiMAX®, Bluetooth®, mobile telephone and data protocols, the public switched telephone network, a proprietary communications network, infrared, and optical.

The MFP 110 may be equipped to receive portable storage media such as USB drives. The MFP 110 includes a user interface subsystem 113, which communicates information to and receives selections from users. The user interface subsystem 113 has a user output device for displaying graphical elements, text data or images to a user and a user input device for receiving user inputs. The user interface subsystem 113 may include a touchscreen, LCD display, touch-panel, alpha-numeric keypad and/or an associated thin client through which a user may interact directly with the MFP 110.

The server 120 is software operating on a server computer connected to the network.

The mobile device 150 is a mobile or handheld PC, a tablet or smart phone, a feature phone, smart watch, or other similar device. The mobile device 150 is representative of one or more end-user devices and in some cases may not be a part of the overall MFP system 100.

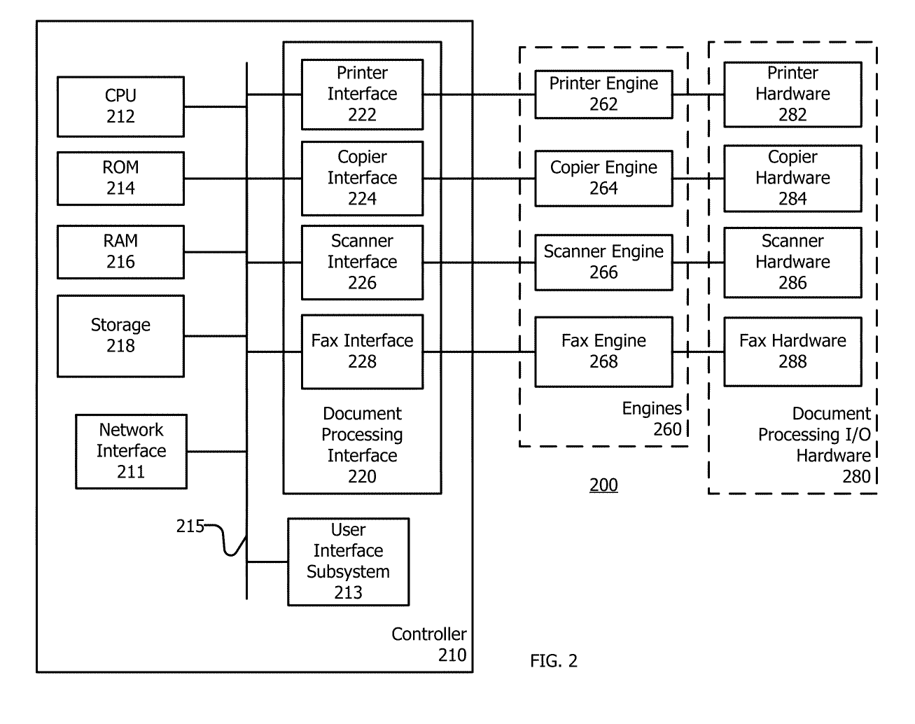

Turning now to FIG. 2 there is shown a block diagram of an MFP 200 which may be the MFP 110 (FIG. 1). The MFP 200 includes a controller 210, engines 260 and document processing I/O hardware 280. The controller 210 includes a CPU 212, a ROM 214, a RAM 216, a storage 218, a network interface 211, a bus 215, a user interface subsystem 213 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 218 provides volatile, bulk or long term storage of data associated with the MFP 200, and may be or include disk, optical, tape or solid state. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from and provide output to the user interface subsystem 213, which may be the user interface subsystem 113 (FIG. 1).

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions.

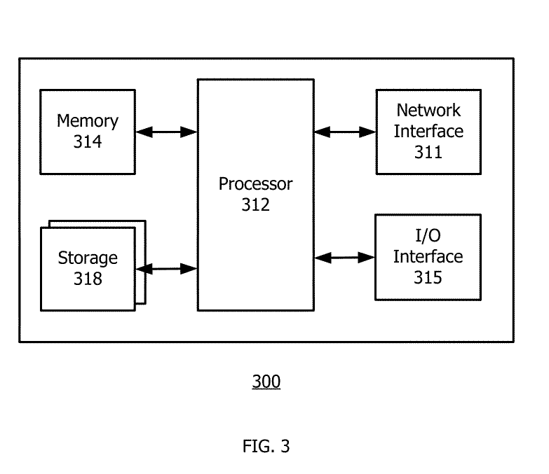

Turning now to FIG. 3 there is shown a computing device 300, which is representative of the server computers, client devices, mobile devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 311 and an I/O interface 315. The processor may be or include one or more microprocessors and, application specific integrated circuits (ASICs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

The network interface 311 includes an interface to a network such as network 102 (FIG. 1).

The I/O interface 315 interfaces the processor 312 to peripherals (not shown) such as displays, keyboards and USB devices.

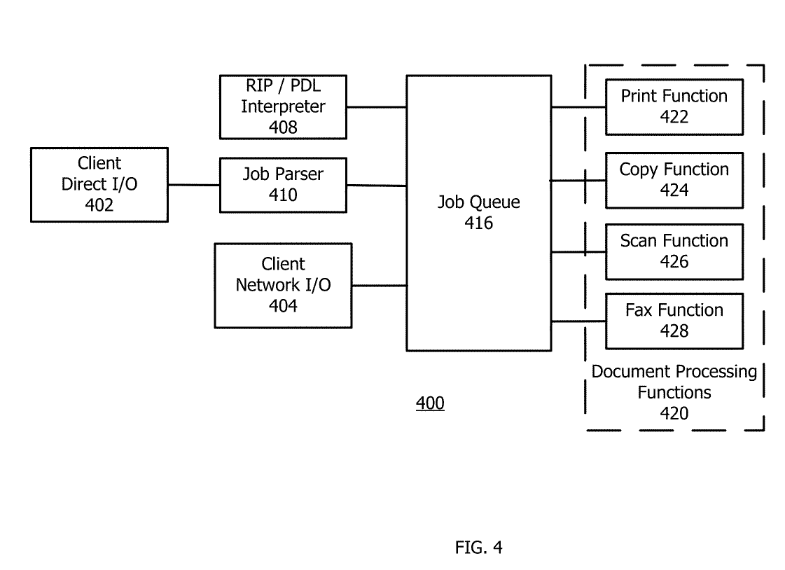

Turning now to FIG. 4 there is shown a block diagram of a software system 400 of an MFP which may operate on the controller 210. The system 400 includes client direct I/O 402, client network I/O 404, a RIP/PDL interpreter 408, a job parser 410, a job queue 416, a series of document processing functions 420 including a print function 422, a copy function 424, a scan function 426 and a fax function 428.

The client direct I/O 402 and the client network I/O 404 provide input and output to the MFP controller. The client direct I/O 402 is for the user interface on the MFP (e.g., user interface subsystem 113), and the client network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP, FTP, UDP, electronic mail TELNET or other network communication protocols.

The RIP/PDL interpreter 408 transforms PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the client network I/O 404. The job queue 416 and associated software is responsible for determining the order in which print, copy, scan and facsimile functions are carried out. These may be executed in the order in which they are received, or may be influenced by the user instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the client direct I/O 402. The client direct I/O 402 may include printing, fax transmission or other input of a document for handling by the system 400.

The print function 422 enables the MFP to print documents and implements each of the various functions related to that process. These include stapling, collating, hole punching, and similar functions. The copy function 424 enables the MFP to perform copy operations and all related functions such as multiple copies, collating, 2 to 1 page copying or 1 to 2 page copying and similar functions. Similarly, the scan function 426 enables the MFP to scan and to perform all related functions such as shrinking scanned documents, storing the documents on a network or emailing those documents to an email address. The fax function 428 enables the MFP to perform facsimile operations and all related functions such as multiple number fax or auto-redial or network-enabled facsimile.

Some or all of the document processing functions 420 may be implemented on a client computer, such as a personal computer or thin client. The user interface for some or all document processing functions may be provided locally by the MFP's user interface subsystem though the document processing function is executed by a computing device separate from but associated with the MFP.

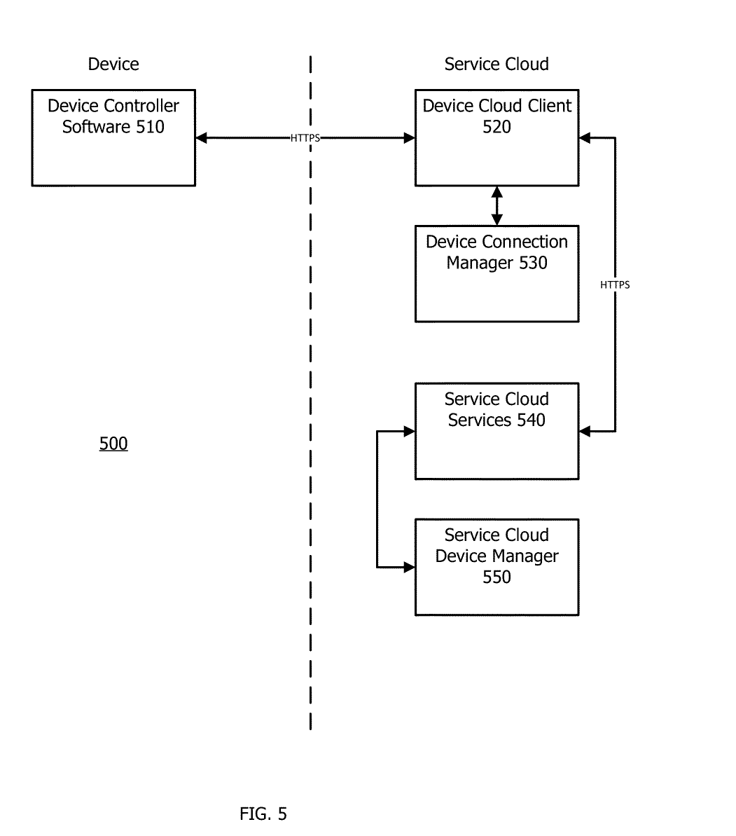

Turning now to FIG. 5, a block diagram of a software system 500 for cloud-based authentication is shown. The system 500 includes both a device side and a cloud side. The device may be, for example, an MFP. The “cloud” is a server or series of servers that operate to enable a device to perform a function involving the server or series of servers.

The device side includes device controller software 510. The device controller software 510 is software that controls the function and operation of the controller 210. Some of those functions and operations are shown in FIG. 2. However, the controller software 510 may also include software for interacting with and using the services of one or more remote servers that make up a “cloud.” The device controller software 510 includes software for interacting with the device cloud client 520 (described below) that enable the device controller software 510 to access services provided by the “cloud.” The connection may be made via secure hypertext transfer protocol (HTTPS).

The cloud side includes a device cloud client 520, a device connection manager 530, service cloud services 540 and service cloud device manager 550.

The device cloud client 520 includes counterpart software for interacting with the device controller software 510 in order to, among other things, authenticate the device controller software 510 to access the server. The device cloud client 520 may operate as a plugin to a larger software suite. The device cloud client 520 may also control additional interactions involving the device controller software 510 including interactions that are related to the cloud performing operations or functions requested by the device controller software 510.

The device connection manager 530 is a sub-component of the device cloud client 520 that handles the direct interaction related to the authentication process between the device controller software 510 and the device cloud client 520. The device connection manager 530 also has access to data storage for storing the device-specific data for a plurality of devices that may interact with the device cloud client 520 and controls the generation of questions posed to a device and used for authentication.

The service cloud services 540 provides operations and functions for use by one or more devices, once authenticated by the device connection manager 530. The service cloud services 540 may include, for example, firmware updates, software updates, consumables management, monitoring and reordering, administrative access via a web portal and other, similar, services. For example, the service cloud services 540 may be an administrative cloud associated with a pool of MFPs.

The service cloud device manager 550 ensures that devices interacting with the service cloud services 540 are authenticated and, if not, may pose the same set of questions to the device controller software 510. In the event of a timeout of authentication credentials, for example, while an operation performed by the service cloud services 540 is being performed, the service cloud device manager 550 may re-authenticate the device controller software 510 in much the same manner as the device connection manager 530. The service cloud device manager 550 may also maintain connections to the service cloud services 540 and ensure that they take place via secure channels, like HTTPS.

Description of Processes

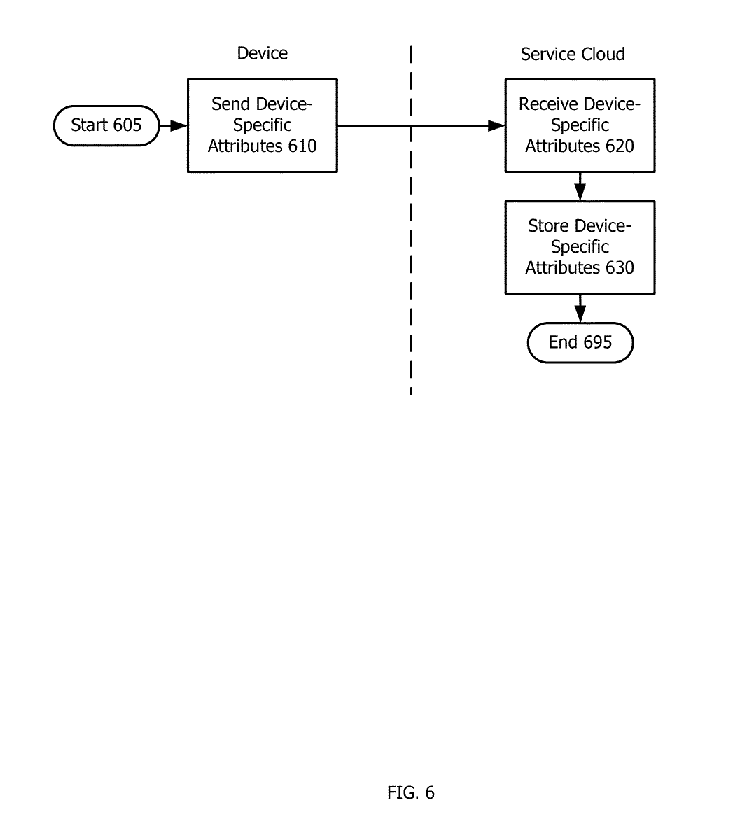

Turning to FIG. 6, a flowchart showing initialization of a cloud-based authentication process is shown. The process begins at 605 and ends at 695, but may take place simultaneously or substantially simultaneously involving a number of devices. The device side and service cloud side are shown divided by a dashed line. The device may be, for example, an MFP. The service cloud is made up of one or more servers.

After the start at 605, the device sends a set of device-specific attributes to a remote server at 610. The remote server may be a part of the service cloud. The device specific attributes may be, for example, a MAC address, a serial number, a model number, a manufacture date, a serial number on a sub-part of the device, a hardware revision number for some or all aspects of the device, or other unique device identifier that would be known only to the device and to the server with which it has previously communicated.

At 620, the device specific attributes are received by the server that is a part of the cloud. This may be, for example, by the device connection manager 530 of the device cloud client 520 of FIG. 5. This may take place using an Internet or other network connection available to the device controller software 510.

At 630, the device-specific attributes are stored, for example, by the device connection manager 530 in storage available to the device connection manager 530.

Once stored at 630, the process may end at 695. However, the process may repeat or continue for other devices initializing with the system.

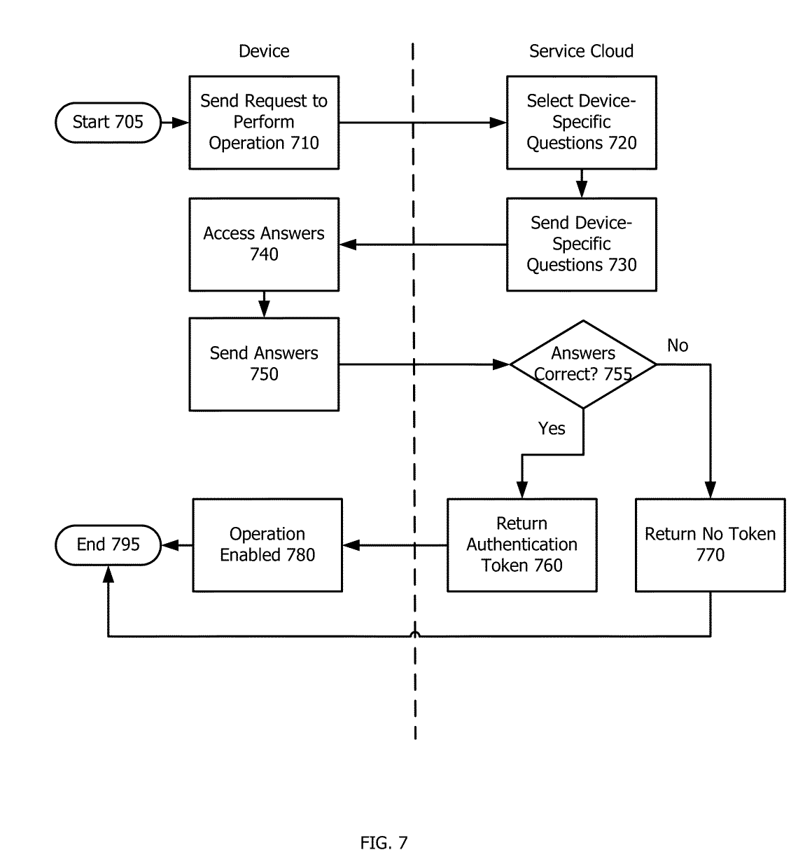

FIG. 7 is a flowchart showing a cloud-based authentication process. Although shown separately, this process begins for a particular device after the process of FIG. 6 is completed. Although shown with a start 705 and an end 795, the process may repeat and may take place many times simultaneously or near-simultaneously between one or more devices and one or more servers making up the service cloud.

After the start 705, the process begins when the device sends a request to perform an operation at 710. The device may be, for example, an MFP and may be requesting that it be authenticated in order to perform routine maintenance tasks, such as obtaining new firmware, checking on the status of consumables and enabling a web portal to access the MFP for an administrator. The service cloud may also enable optical character recognition operations, scanning to cloud locations, emailing and other, similar operations that may be performed by an MFP in conjunction with a server.

Next, the server that is a part of the service cloud selects device-specific questions at 720. These questions are drawn from the data transmitted at 610, received at 620, and stored at 630. These questions may be a subset of the entire device-specific question set that is available. For example, the questions selected may be selected at random and may include only three of a data set made up of twenty available questions.

At 730, the device-specific questions are sent to the device in the form of a question. In this way, the data transmitted does not include the answers to those questions. So, any third party intercepting the questions will still not have any sensitive data.

Next, the answers to those questions are accessed by the device at 740. This access may be to a specific storage location dedicated to the questions or may merely be an always-available summary of data about the device. For example, the device need not specifically store its serial number in a location dedicated to these questions, because the device is typically aware, at least at a software level, of its own serial number. Similarly, a MAC address is easily available to any device incorporating a network card. Thus, the answers may be accessed at 740.

The answers are then transmitted to the server at 750. This transmission of answers relies upon HTTPS to ensure that the transmission is secure.

At 755, a determination whether the answers are correct is made. If the answers are correct (“yes” at 755), then an authentication token (enabling the device to communicate with the service to perform operations) is transmitted to the device at 760 and the requested operation or operations are enabled at 780. Further follow-on interactions between the device and the server (not shown) may be required to complete the requested operations.

If the answers are not correct (“no” at 755), then no token is returned at 770 and the process ends at 795. In this case, no follow-on interactions will be accepted until an authentication token is returned at 760. This ensures that non-authenticated devices cannot interact with the server, potentially causing harm to the system, overloading it, or otherwise wasting resources meant for authorized devices.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A method for authenticating a device for access to a server comprising:
receiving a set of device-specific attributes, unique only to the device, from the device as a part of a device registration process;
storing the set of device-specific attributes in a device attribute storage;
receiving a request to perform an operation using the device and involving the server;
transmitting a set of device-specific challenge questions derived from the set of device-specific attributes to the device;
receiving responses to the set of device-specific challenge questions from the device;
confirming that the responses each conform to the set of device-specific attributes; and
enabling the operation involving the server.

2. The method of claim 1 wherein the set of device-specific attributes includes a MAC address, a serial number, and a device model.

3. The method of claim 1 wherein the operation is an update operation and the device is a multifunction peripheral and wherein the server is used to obtain data to be used to update the multifunction peripheral to complete the update operation.

4. The method of claim 1 wherein the device-specific challenge questions are randomly selected from the set of device-specific attributes.

5. The method of claim 4 wherein the device-specific challenge questions are a group of three questions, and a correct response to all three is required before the operation is enabled.

6. The method of claim 1 wherein the enabling the operation includes transmitting an authentication token to the device.

7. An apparatus comprising a server for:
receiving a set of device-specific attributes, unique only to the device, from a device as a part of a device registration process;
storing the set of device-specific attributes in a device attribute storage;
receiving a request to perform an operation using the device and involving the server;
transmitting a set of device-specific challenge questions derived from the set of device-specific attributes to the device;
receiving responses to the set of device-specific challenge questions from the device;
confirming that the responses each conform to the set of device-specific attributes; and
enabling the operation involving the server.

8. The apparatus of claim 7 wherein the set of device-specific attributes includes a MAC address, a serial number, and a device model.

9. The apparatus of claim 7 wherein the operation is an update operation and the device is a multifunction peripheral and wherein the server is used to obtain data to be used to update the multifunction peripheral to complete the update operation.

10. The apparatus of claim 7 wherein the device-specific challenge questions are randomly selected from the set of device-specific attributes.

11. The apparatus of claim 10 wherein the device-specific challenge questions are a group of three questions, and a correct response to all three is required before the operation is enabled.

12. The apparatus of claim 7 wherein the enabling the operation includes transmitting an authentication token to the device.

13. An apparatus comprising a storage device storing instructions which when executed by a processor will cause the processor to authenticate a device for access to a server, the instructions for:
receiving a set of device-specific attributes, unique only to the device, from the device as a part of a device registration process;
storing the set of device-specific attributes in a device attribute storage;
receiving a request to perform an operation using the device and involving the remote server;
transmitting a set of device-specific challenge questions derived from the set of device-specific attributes to the device;
receiving responses to the set of device-specific challenge questions from the device;
confirming that the responses each conform to the set of device-specific attributes; and
enabling the operation involving the server.

14. The apparatus of claim 13 wherein the set of device-specific attributes includes a MAC address, a serial number, and a device model.

15. The apparatus of claim 13 wherein the operation is an update operation and the device is a multifunction peripheral and wherein the server is used to obtain data to be used to update the multifunction peripheral to complete the update operation.

16. The apparatus of claim 13 wherein the device-specific challenge questions are randomly selected from the set of device-specific attributes.

17. The apparatus of claim 16 wherein the device-specific challenge questions are a group of three questions, and a correct response to all three is required before the operation is enabled.

18. The apparatus of claim 13 wherein the enabling the operation includes transmitting an authentication token to the device.
